(19) United States
(12) Patent Application Publication
(10) Pub. No.: US 2015/0334200 A1
(43) Pub. Date: Nov. 19, 2015

(54) Systems and Methods for Automated Giving Platform

(71) Applicant: Andrea Yoder Clark, San Diego, CA (US)

(72) Inventor: Andrea Yoder Clark, San Diego, CA (US)

(21) Appl. No.: 14/716,859

(22) Filed: May 19, 2015

Related U.S. Application Data
(60) Provisional application No. 62/000,516, filed on May 19, 2014.

(51) Int. Cl. H04L 29/08

(52) U.S. Cl. CPC H04L 67/22; H04L 67/10; H04L 67/02

(57) ABSTRACT

An automated giving platform is described that allows users to post social giving activities to a newsfeed. The posts can include a variety of information, such as a picture, description, and one or more tags that can categorize the type of social giving activity being posted. Points can be awarded to the social giving activities that users post to the newsfeed of the social giving platform. In addition, users can form social circles and points that are earned by individual users of a social circle can also be awarded to the social circle. Awarded points and activities posted by users, including their associated circles, can be managed by the platform in order to provide analytics related to how much social giving is being performed by users and social circles.

### CROSS-REFERENCE TO RELATED APPLICATION

The current application is claims priority under 35 U.S.C. §119(e) to U.S. Provisional patent application Ser. No. 62/000,516, filed on May 19, 2014 and entitled Systems and Methods for Automated Giving Platforms,” which is incorporated by reference herein in its entirety.

### TECHNICAL FIELD

The subject matter described herein relates to an automated platform that allows users to post giving activities to a newsfeed, accumulate points for the giving activities, and join social giving circles, and more particularly the platform is configured to track points and information related to the giving activities based on a per user and per social giving circle basis.

### BACKGROUND

People and organizations can participate in social giving activities, such as providing assistance to the homeless, veterans of war, animals, and the environment. In addition, giving activities can include the donation of items and money toward charitable causes by either people or organizations. Such giving activities can be beneficial for both individuals and society as a whole.

### SUMMARY

Aspects of the current subject matter can include an automated giving platform that can post giving activities to a newsfeed and award points to users and user groups (i.e., social circles) that are connected through the automated giving platform. In addition, the giving platform can keep track of and provide statistics related to a variety of information related to the users and their associated giving activities.

In one aspect, a method of the automated giving platform includes receiving, by an automated giving platform, a user input from a device associated with a user, the user input can include a description of a giving activity, a category tag, an amount of time associated with the giving activity, and a social graph associated with the user input. The social graph can represent one or more other users connected with the user via a communications network associated with the automated giving platform. The method can further include generating, by the automated giving platform, a newsfeed including the user input. The newsfeed can be available to each of the one or more other users via the communications network. In addition, the method can include assigning, by the automated giving platform, a value to the user input based on the giving activity. The value can be stored in a value database associated with the automated giving platform, and the value can be added to a value total accumulated by the user. Additionally, the method can include storing, by the automated giving platform, the amount of time in a time database associated with the automated giving platform, with the amount of time being added to a time total accumulated by the user. Furthermore, the method can include generating, by the automated giving platform, a webpage that is viewable on a computing device by the user and transmissible over the communications network to the plurality of other users, with the webpage including the value total and the time total.

In some variations one or more of the following features can optionally be included in any feasible combination. For example, the value can be assigned based on at least one of the amount of time associated with the giving activity, the category tag, and a frequency of the giving activity. The category tag can be configured to allow the automated giving platform to generate data showing one or more of a frequency, a percentage of time, and a number of times the user performed a type of giving activity. The automated giving platform can include a social value database that adds values assigned to the user and each of the plurality of other users to a social value total, the social value total indicating how much the social graph has participated in giving activities. The automated giving platform can include a social time database that collects time totals accumulated by the user and each of the plurality of other users and generates a social time total that indicates how much time the social graph has spent participating in giving activities. The automated giving platform can include a social location database that collects location data associated with each giving activity performed by the user and each of the plurality of other users and generates a social location model indicating an amount of giving activity performed in various locations by the user and the plurality of other users. In addition, the automated giving platform can include a location database that collects a location data point associated with the giving activity for generating a location model indicating an amount of giving activity performed in various locations by the user. Furthermore, the method can further include generating a social totals webpage that is viewable on a computing device and includes the social value total, the social time total, and the social location model.

Systems and methods consistent with this approach are described as well as articles that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an example system for implementing an automated giving platform;

FIG. 2 shows an implementation of an account setup page of the automated giving platform;

FIGS. 3A and 3B show an implementation of an activity posting page of the automated giving platform;

FIG. 4 shows an implementation of a navigation page of the automated giving platform;

FIG. 5A shows an implementation of a circle profile page of the automated giving platform;

FIG. 5B shows an implementation of a social circle create page of the automated giving platform;

FIG. 5C shows an implementation of a social circle invitation page of the automated giving platform;

FIG. 6 shows an implementation of a statistics page of the automated giving platform; and

FIG. 7 shows a process flow chart illustrating features of a method consistent with one or more implementations of the current subject matter.

When practical, similar reference numbers denote similar structures, features, or elements.

### DETAILED DESCRIPTION

A social giving platform is described that allows users to post social giving activities to a newsfeed. Such postings allow the social giving platform and user to track and quantify how much giving the user is performing. The giving activities can include a variety of acts of social good, such as volunteering to help the homeless, pick up trash, assist veterans, etc. The posts can include a variety of information, such as a picture, description, and one or more tags that can categorize the type of social giving activity being posted. Points can be awarded to the social giving activities that users post to the newsfeed of the social giving platform. In addition, users can form social circles and points that are earned by individual users of a social circle can also be awarded to the social circle. Awarded points and activities posted by users, including their associated circles, can be managed by the platform in order to provide statistics related to how much social giving is being performed by users and social circles. The social giving platform can thus provide incentives and recognition to users and social circles that participate in social giving, as well as provide societal advantages as a result of the social giving being encouraged and performed.

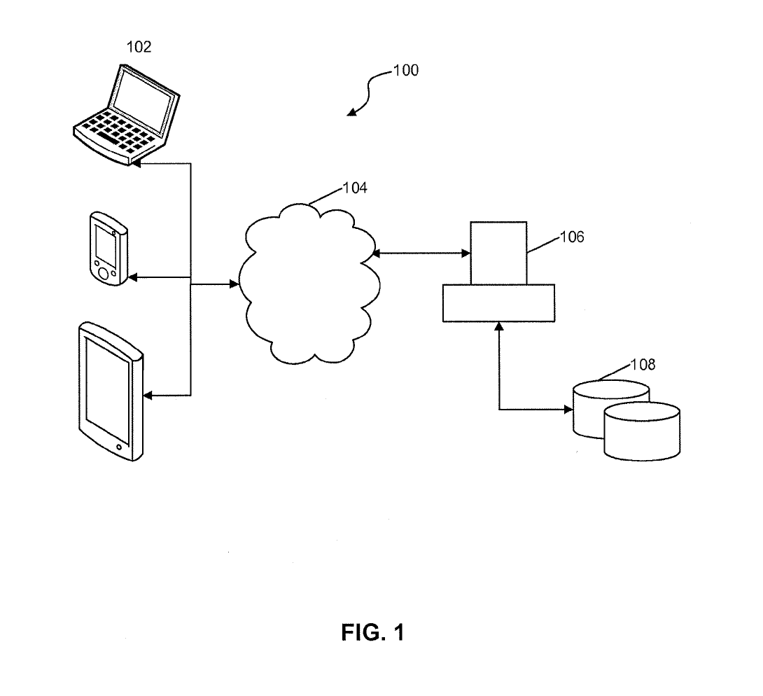

FIG. 1 shows an example system 100 configured to implement the systems and methods described herein. As can be seen, users can access an automated giving platform 106 via a computerized device 102. For example, if the device 102 is a mobile device, then the system 100 can be configured such that the user can download (e.g., via the internet 104) an application to the mobile device in order to allow the user to access and interface with the automated giving platform 106. A user can also access the automated giving platform 106 using another type of application such as a browser. The automated giving platform 106 can comprise the resources, hardware and software required to implement the processes and functions described herein, including any thin client or application resident on the users' device 102.

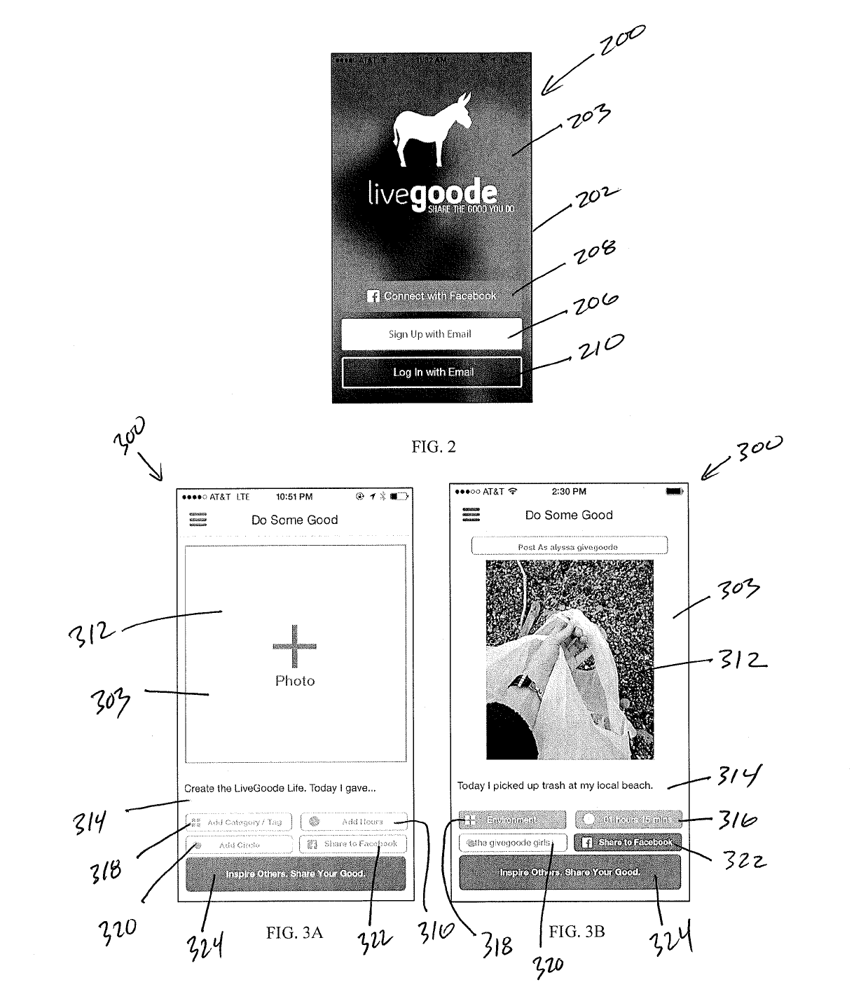

FIG. 2 shows an implementation of a user interface 200 provided by the automated giving platform to a display 202 of a device, such as a mobile device. The user interface 200 shown in FIG. 2 is an account setup page 203 of the automated giving platform 106. In accordance with some exemplary implementations, the automated giving platform 106 includes an application program that is executable by a processor in the device. The display 202 can be a touch-sensitive display, and the user interface 200 can include a first input region 206 for receiving a user's input in order to provide the user with a user account. For example, the first input region 206 can allow a user to enter in an email address that will be associated with the user's account with the automated giving platform. The user interface 200 can include a second input region 208 that can allow a user to set up a user account using Facebook or other social media platforms. For users that have already setup a user account with the automated giving platform, a third input region 210 can allow such users to login, such as with an email account associated with their user account. Once logged in, for example, a user can post a giving activity to the user's profile page, which can be available for viewing on a newsfeed by other users of the automated giving platform.

FIGS. 3A and 3B show an implementation user interface 300 of the automated giving platform 106 that is an activity posting page 303 configured to allow a user to post a giving event or activity on the user's profile, which can appear on a newsfeed provided by the automated giving platform 106. The activity posting page 303 can include a photo input region 312 that can allow a user to post a picture or video, such as a picture or video associated with the giving event. In addition, the activity posting page 303 can include a text input region 314, such as for allowing a user to describe the giving activity or event that the user participated in (e.g., “today I picked up trash at my local beach”). The activity posting page 303 can also include a time input region 316 that can allow a user to input how much time the user spent performing or participating in the giving activity. The activity posting page 303 can include a tag or category input region 318 that, when selected by a user, can provide a variety of categories and/or tags that can be associated with the giving activity. For example, as shown in FIG. 3B, the user can select an “environment” tag to associate with a giving activity post regarding picking up trash. Other tags for giving activities can be associated with the homeless, veterans, or random acts of kindness (e.g., placing change in a parking meter for another person).

In addition, the activity posting page 303 can include a circle input region 320 that can allow the user to associate the giving activity with a social circle. Once the user has completed the giving activity post, the user can select to either share the post on Facebook or other social media networks (e.g., Twitter, etc.), such as by selecting a share input region 322, or the user can select a post input region 324 that allows the giving activity post to be shared on the newsfeed generated by the automated giving platform. Once on the newsfeed, other users of the automated giving platform can view the giving activity post.

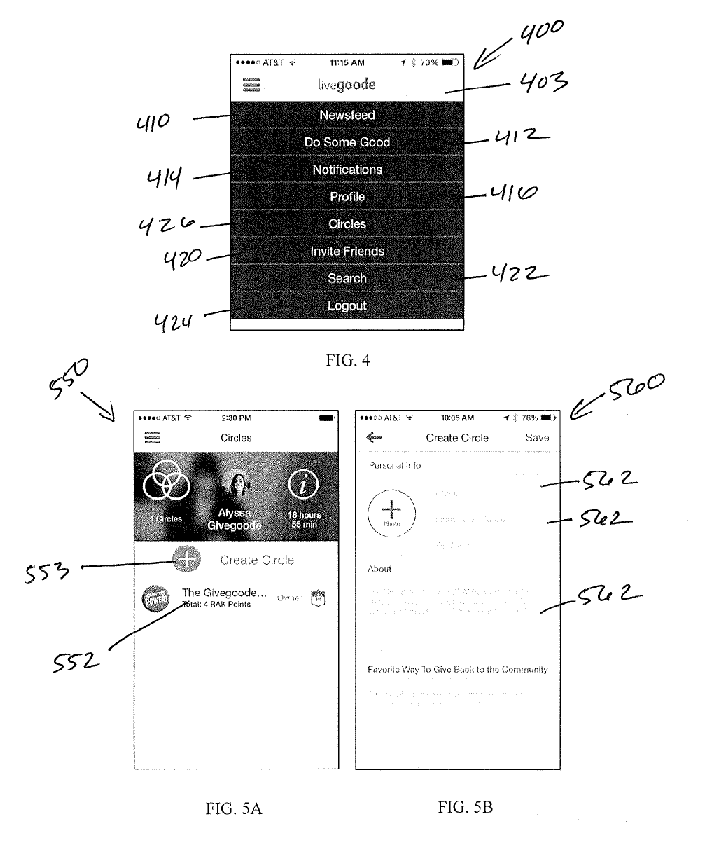

FIG. 4 shows an implementation user interface 400 of the automated giving platform 106 that is a navigation page 403 configured to allow a user to navigate (e.g., via a link) to a variety of pages provided by the automated giving platform 106. For example, the navigation page 403 can include a newsfeed link 410 that, when selected by a user, directs the user to a newsfeed generated by the automated giving platform 106, such as a general or private (e.g., specific to members of a social circle) newsfeed. The newsfeed can include an accumulation of giving activity posts that have been input by users of the automated giving platform. The newsfeed, for example, can display the giving activity posts by the users, thereby allowing users of the automated giving platform to view information related to giving activities being performed by other users of the automated giving platform (e.g., time spent, category of giving activity, associated circles, description of the giving activity, picture of the activity, location of the activity etc.).

In addition, the navigation page 403 can include a posting link 412 that, when selected by a user, directs the user to an activity posting page (such as the activity posting page 303 in FIGS. 3A and 3B) for allowing the user to post a giving activity to the newsfeed. The navigation page 403 can also include a notification link 414 that, when selected by a user, directs the user to a notification page that lists notifications for the user to review. Notifications can include, for example, a request to add other users to your social circle or to join a social circle, which the user can then accept or reject.

The navigation page 403 can additionally include a profile link 416 that, when selected by a user, directs the user to a profile page that includes a variety of information related to the user. For example, the profile page can include information related to how many and which social circles the user is associated with, how many total points the user has accumulated, and a total amount of time spent participating in giving activities. Any giving activity posts that the user has posted to then newsfeed of the automated giving platform can also be available for viewing on the profile page. The users profile can also include information related to the gender, age, company the user works for, and a zip code, such as a zip code of where the user lives or works.

The navigation page 403 can additionally include an invitation link 420 that, when selected by a user, directs the user to an invitation page that allows the users to invite new users to join the automated giving platform, including being a linked user (or “friend”) to the user. In addition, the invitation page can allow the user to execute, via the application program, an invitation to the user's “friends” designated on any one or more social networking platforms (e.g., Facebook). The invitation page can further allow the user to execute, via the application program, an invitation to the user's “friends” designated on any one or more electronic mail accounts (e.g., Gmail, Yahoo Mail). Finally, the invitation page can allow the user to execute, via the application program, an invitation to the user's “friends” designated on any one or more Internet portals. Each of the invitations, when executed by the application program, generates and sends an invitation to the designated “friends” via a communications network, to participate in the automated giving platform. The participation can include each invitee downloading or executing their own local application on their own mobile device.

The navigation page 403 can additionally include a search link 422 that, when selected by a user, directs the user to a search page that allows the user to search for other users, organizations, or social circles of the automated giving platform. For example, the search page can allow a user to enter searching information (e.g., a name) in order for the augmented giving platform to filter users, organizations and/or circles that match the searching information and provide results to the user. The user can then select search results in order to view information related to the user, organization and/or circle listed in the search results. In addition, the user can invite to connect (i.e., become “friends”) with users and/or organizations, or request to join circles listed in the search results.

The navigation page 403 can additionally include a logout link 424 that, when selected by a user, directs the user to a logout page that can allow the user to logout from the automated giving platform.

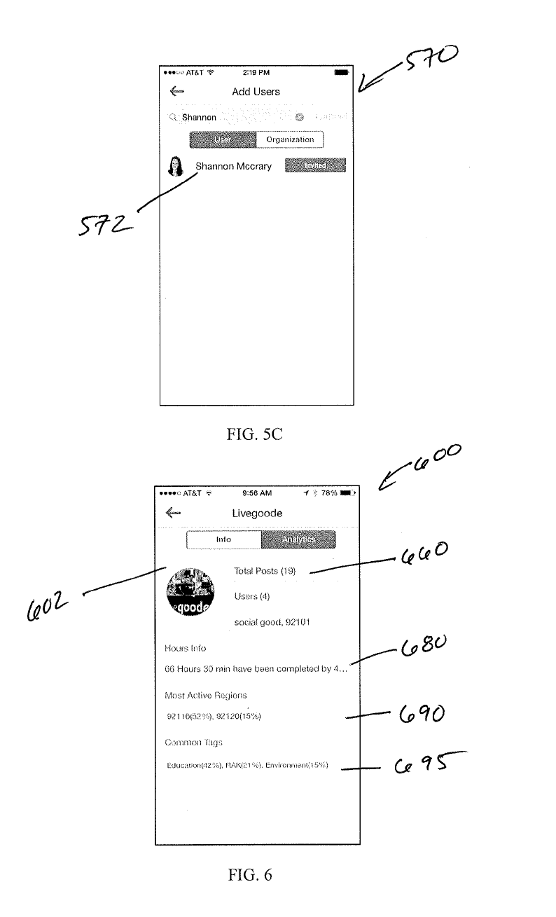

Furthermore, the navigation page 403 can additionally include a social circle link 426 that, when selected by a user, directs the user to a user circle profile page 550, as shown in FIG. 5A, that includes a variety of information related to social circles 552 the user is associated with (i.e., social circles the user has joined or formed). For example, the user circle profile page 550 can also include a create circle input 553 that can allow the user to create a new social circle, as shown in FIG. 5B.

FIG. 5B shows a social circle create page 560 provided by the automated giving platform 160, which can be used to create and setup a social circle. For example, the social circle create page 560 can include a number of entry fields 562 that can allow the user creating the social circle to enter in contact information (e.g., organization name, zip code, etc.) and descriptions related to the social circle. Social circles can have their own provide newsfeed that is accessible only to members of the social circle. In addition, the user who creates the social circle can become the owner of the social circle. The owner of a social circle can manage a variety of aspects of the social circle, such as adding (i.e., inviting) and deleting users of the social circle (including users and organizations) and posting giving activities by the social circle.

FIG. 5C shows a social circle invitation page 570 provided by the automated giving platform 160, which can be used to invite users 572 and organizations to the social circle. Once invited, the users and organizations can accept or reject the invitation. Information associated with either the user or organization that accepts the invitation will then be incorporated into the social circle's analytics (e.g., total points earned, total hours performed, locations activities were performed, sectors given to, etc.). In addition, users and organizations that are a part of a social circle can view a social circle newsfeed that can only be viewed by users and organizations of the social circle and include posts from only users and organizations of the social circle.

FIG. 6 shows an implementation user interface 600 of the automated giving platform 106 that is a statistics page 602 configured to show data associated with a user, organization or circle. For example, the statistics page 602 can include a total number of posts, a total amount of time spent participating in giving activities, common tags associated with social sectors that were given to (which can be identified as percentages of use), and regions where the giving activities have occurred (including a percentage as to how much of the total giving activities occurred in each region).

For example, the statistics page 602 for a social circle can include a point total 660, which can indicate a total number of points accumulated by all of the users of the social circle. Similarly, the statistics page for a social circle can include a time total 680, which can indicate a total amount of time accumulated by all of the users of the social circle. A statistics page for a single user or organization, for example, can include just the total number of points accumulated or amount of time spent by the user or organization. In general, a statistics page 602 for a social circle will include a total for all of the users in the social circle, whereas a statistics page for a user or organization will include a total for just the user or organization.

The statistics page 602 can also include a location model 690 that can include a variety of information related to regions (e.g., zip codes) where the giving activities took place. For example, a user or social circle can have location information associated with one or more giving activity post. The automated giving platform can then generate the location model that can provide an easy interpretation as to where and how often giving activities are performed (e.g., percentages associated with regions).

The statistics page 602 can also include a category model 695 that can include a variety of information related to categories or tags that were associated with giving activity posts. For example, a user or social circle can have categories or tags associated with one or more giving activity posts, as discussed above. The automated giving platform can then generate the category model that can provide an easy interpretation as to which categories and tags have been used by the user, as well as how often they are associated with giving activity posts (e.g., percentages associated with each category/tag).

Points can be awarded to users and organizations by the automated giving platform in a variety of ways. For example, the points can be awarded on a per-posting basis, such that each time a user or organization posts a giving activity, the user or organization is awarded a number of points. In some implementations, points can be awarded based on a frequency of giving activity, such as how frequent a user or organization participates in a particular giving activity. In some implementations, points can be awarded based on an amount of time spent on each giving activity. However, points can be awarded in any number of ways and the awarding of points are not limited to the examples described herein.

In some implementations, the automated giving platform can encourage users to participate in either specific or additional giving activities, which can increase the user's own point accumulation (i.e., user point total) as well as associated social circles (i.e., circle point totals). Badges and other gamification techniques can be used to recognize and incentivize users of the automated giving platform to perform additional giving activities. The automated giving platform can capture the giving behavior of the users and organizations. This behavior can then be stored in one or more database managed by the automated giving platform. The data can be mined and shared, such as with a variety of organizations, companies, groups, etc.

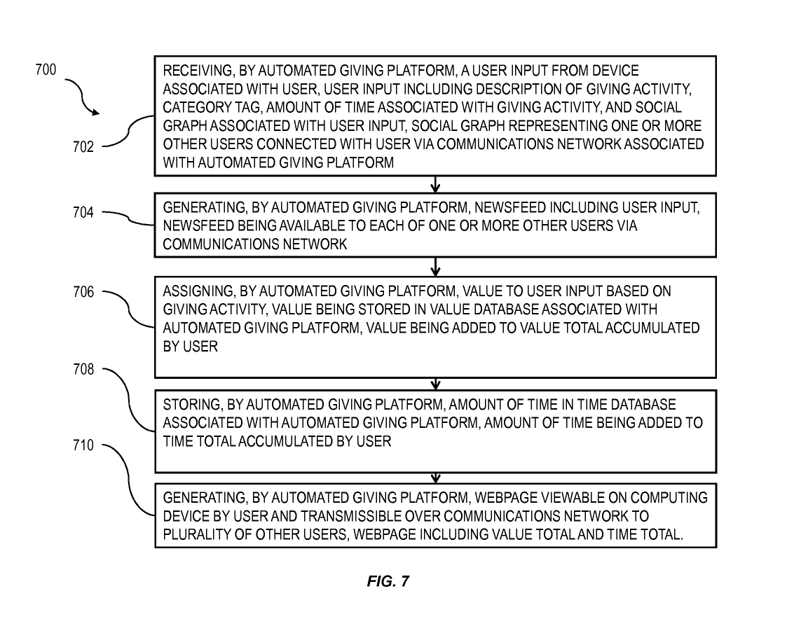

FIG. 7 shows a process flow chart 700 illustrating features of a method consistent with one or more implementations of the current subject matter. It will be understood that other implementations may include or exclude certain features. At 702, an automated giving platform can receive a user input from a device associated with a user. The user input can include a description of a giving activity, a category tag, an amount of time associated with the giving activity, and a social graph (i.e., social circle) associated with the user input. The social graph can represent one or more other users connected with the user via a communications network associated with the automated giving platform. At 704, the automated giving platform can generate a newsfeed including the user input. The newsfeed can be available to each of the one or more other users via the communications network. At 706, the automated giving platform can assign a value to the user input based on the giving activity. The value can be stored in a point database associated with the automated giving platform. The value can be added to a value total accumulated by the user. At 708, the automated giving platform can store the amount of time in a time database associated with the automated giving platform. The amount of time can be added to a time total accumulated by the user. At 710, the automated giving platform can generate a webpage that is viewable on a computing device by the user and transmissible over the communications network to the plurality of other users. The webpage can include the value total and the time total.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1) A method comprising:
receiving, by an automated giving platform, a user input from a device associated with a user, the user input including a description of a giving activity, a category tag, an amount of time associated with the giving activity, and a social graph associated with the user input, the social graph representing one or more other users connected with the user via a communications network associated with the automated giving platform;
generating, by the automated giving platform, a newsfeed including the user input, the newsfeed being available to each of the one or more other users via the communications network;
assigning, by the automated giving platform, a value to the user input based on the giving activity, the value being stored in a value database associated with the automated giving platform, the value being added to a value total accumulated by the user;
storing, by the automated giving platform, the amount of time in a time database associated with the automated giving platform, the amount of time being added to a time total accumulated by the user; and
generating, by the automated giving platform, a webpage that is viewable on a computing device by the user and transmissible over the communications network to the plurality of other users, the webpage including the value total and the time total.

2) The method of claim 1, wherein the value is assigned based on at least one of the amount of time associated with the giving activity, the category tag, and a frequency of the giving activity.

3) The method of claim 1, wherein the category tag is configured to allow the automated giving platform to generate data showing one or more of a frequency, a percentage of time, and a number of times the user performed a type of giving activity.

4) The method of claim 1, wherein the automated giving platform includes a social value database that adds values assigned to the user and each of the plurality of other users to a social value total, the social value total indicating how much the social graph has participated in giving activities.

5) The method of claim 4, wherein the automated giving platform includes a social time database that collects time totals accumulated by the user and each of the plurality of other users and generates a social time total that indicates how much time the social graph has spent participating in giving activities.

6) The method of claim 5, wherein the automated giving platform includes a social location database that collects location data associated with each giving activity performed by the user and each of the plurality of other users and generates a social location model indicating an amount of giving activity performed in various locations by the user and the plurality of other users.

7) The method of claim 6, further comprising generating a social totals webpage that is viewable on a computing device and includes the social value total, the social time total, and the social location model.

8) The method of claim 1, wherein the automated giving platform includes a location database that collects a location data point associated with the giving activity for generating a location model indicating an amount of giving activity performed in various locations by the user.

9) A system comprising:
at least one programmable processor; and
a machine-readable medium storing instructions that, when executed by the at least one processor, cause the at least one programmable processor to perform operations comprising:
receiving, by an automated giving platform, a user input from a device associated with a user, the user input including a description of a giving activity, a category tag, an amount of time associated with the giving activity, and a social graph associated with the user input, the social graph representing one or more other users connected with the user via a communications network associated with the automated giving platform;
generating, by the automated giving platform, a newsfeed including the user input, the newsfeed being available to each of the one or more other users via the communications network;
assigning, by the automated giving platform, a value to the user input based on the giving activity, the value being stored in a value database associated with the automated giving platform, the value being added to a value total accumulated by the user;
storing, by the automated giving platform, the amount of time in a time database associated with the automated giving platform, the amount of time being added to a time total accumulated by the user; and
generating, by the automated giving platform, a webpage that is viewable on a computing device by the user and transmissible over the communications network to the plurality of other users, the webpage including the value total and the time total.

10) The method of claim 9, wherein the value is assigned based on at least one of the amount of time associated with the giving activity, the category tag, and a frequency of the giving activity.

11) The method of claim 9, wherein the category tag is configured to allow the automated giving platform to generate data showing one or more of a frequency, a percentage of time, and a number of times the user performed a type of giving activity.

12) The method of claim 9, wherein the automated giving platform includes a social value database that adds values assigned to the user and each of the plurality of other users to a social value total, the social value total indicating how much the social graph has participated in giving activities.

13) The method of claim 12, wherein the automated giving platform includes a social time database that collects time totals accumulated by the user and each of the plurality of other users and generates a social time total that indicates how much time the social graph has spent participating in giving activities.

14) The method of claim 13, wherein the automated giving platform includes a social location database that collects location data associated with each giving activity performed by the user and each of the plurality of other users and generates a social location model indicating an amount of giving activity performed in various locations by the user and the plurality of other users.

15) The method of claim 14, further comprising generating a social totals webpage that is viewable on a computing device and includes the social value total, the social time total, and the social location model.

16) The method of claim 9, wherein the automated giving platform includes a location database that collects a location data point associated with the giving activity for generating a location model indicating an amount of giving activity performed in various locations by the user.
